(19) United States
(12) Patent Application Publication
(10) Pub. No.: US 2020/0233702 A1
(43) Pub. Date: Jul. 23, 2020

(54) CONTROL APPARATUS AND COMPUTER READABLE MEDIUM

(71) Applicant: Mitsubishi Electric Corporation, Tokyo (JP)

(72) Inventor: Ryo OKABE, Tokyo (JP)

(73) Assignee: Mitsubishi Electric Corporation, Tokyo (JP)

(21) Appl. No.: 16/487,026

(22) PCT Filed: Mar. 21, 2017
(86) PCT No.: PCT/JP2017/011245

§ 371 Date: Aug. 19, 2019

(51) Int. Cl. G06F 9/48; G06F 9/455

(52) U.S. Cl. CPC G06F 9/4837; G06F 9/4818; G06F 2009/45591; G06F 2009/45575; G06F 9/45558

(57) ABSTRACT

A microcontroller (200) performs first monitoring in accordance with a first monitoring rule when a priority control interruption occurs in a first time partition for execution of general control, and performs second monitoring in accordance with a second monitoring rule when a priority control interruption occurs in a second time partition for execution of safety monitoring. The microcontroller performs safety control in each of cases where a violation of the first monitoring rule occurs in the first time partition, and where a violation of the second monitoring rule occurs in the second time partition.

### TECHNICAL FIELD

The present, invention relates to a technology for performing various controls while performing safety monitoring.

### BACKGROUND ART

According to ISO 26262, which is a functional safety standard for automobiles, and IEC 60335-1, which is a safety standard for household electrical appliances, it is necessary to perform a safety monitoring process, such as hardware failure diagnosis and monitoring of external dangerous states and abnormal events with sensors, in addition to a normal control process.

In such a safety monitoring process, it is necessary to assign a CPU time on the basis of a fault tolerant time interval (FTTI) defined by a system. CPU is an abbreviation for central processing unit.

For example, in a system in which an allowable time from failure occurrence to failure detection is within 1,500 milliseconds, when it takes 500 milliseconds to diagnose all areas to be subjected to hardware diagnosis, it is necessary to ensure that 500 milliseconds of the CPU time is assigned for a 1,500 milliseconds period for the safety monitoring process. If the CPU time assigned to the safety monitoring process is shorter than 500 milliseconds, the FTTI defined by the system may not be protected in the event of a failure.

In the technique disclosed in Patent Literature 1, a CPU time is independently assigned for each of a normal control process and a safety monitoring process by time partitioning. Therefore, it is ensured that a constant CPU time is assigned for a constant cycle for the safety monitoring process.

Non Patent Literature 1 discloses securing of an idle window at the end of each cycle in time partitioning.

When it is possible to accept an interruption from a normal control process at a time partition of a safety monitoring process, and an interruption from the normal control process occurs in the time partition of the safety monitoring process, a CPU time assigned to the idle window is transferred to the time partition of the safety monitoring process. This makes it possible to ensure a CPU time of the safety monitoring process while suppressing delay of the normal control process.

Patent Literature 2 and Patent Literature 3 disclose techniques for monitoring an occurrence frequency of interruptions and an execution time of an interruption process.

If such monitoring is performed for interruptions from a normal control process, it is possible to ensure the CPU time of the safety monitoring process for when it is possible to accept an interruption from the normal control process in a time partition of the safety monitoring process.

### CITATION LIST

### Patent Literature

Patent Literature 1: WO 2012/104901 A

Patent Literature 2: WO 2016/046931 A

Patent Literature 3: JP H07-110774 A

### Non Patent Literature

Non Patent Literature 1: Hiroaki TAKADA, “Introducing a new temporal partitioning scheme to AUTOSAR OS” 8th AUTOSAR Open Conference, Oct. 29, 2015.

### SUMMARY OF INVENTION

### Technical Problem

Generally, in a powertrain system electronic control unit (ECU) such as engine control and a chassis system ECU such as electronic power steering (EPS), a control process such as motor control or power conversion, a non-control process such as communication processing or monitoring daemon, and a safety monitoring process such as hardware failure diagnosis or external abnormality monitoring are operated.

The control process is a process that is activated by an interruption generated at intervals of several tens of microseconds to several hundreds of microseconds, to perform feedback control. In the control process, it is required to minimize delay. Further, the control process should not be interrupted by other processes. That is, the control process is executed with the highest priority among normal processing.

The non-control process allows a large delay as compared to the control process, and can also be interrupted by other processing. The non-control process has a characteristic of being activated from periodic processing on millisecond order, and being activated when there is an enough CPU time.

The safety monitoring process allows a large delay as compared to the control process, and can also be interrupted by other processing. However, as described above, it is necessary to ensure that a predetermined CPU time is assigned to the safety monitoring process in a predetermined cycle of several hundred milliseconds to several thousand milliseconds.

The technique disclosed in Non Patent Literature 1 suppresses delay of a control process while ensuring a CPU time of a safety monitoring process. However, since it is necessary to secure an idle window at the end of each cycle in time partitioning, an unused CPU time occurs, disabling effective utilization of the CPU time.

By accepting an interruption from the control process in a time partition of the safety monitoring process, and monitoring an occurrence frequency of interruptions from the control process and an execution time of an interruption process by tire techniques of Patent Literature 2 and Patent Literature 3, it is possible to ensure the CPU time of the safety monitoring process.

However, since this method monitors an occurrence frequency of interruptions and an execution time of the interruption process in all time partitions, a violation may be detected in a time partition of a process other than the safety monitoring process. As a result, although the CPU time of the safety monitoring process is ensured and there is no problem in the device, it is determined that an abnormality has occurred in the device.

Further, since the control process should not be interrupted, it is necessary to operate the control process with higher priority than a switching process of the time partition. Therefore, if an interruption from the control process occurs immediately before the completion of the time partition immediately before the time partition of the safety monitoring process, switching of the time partition is delayed, and the CPU time of the time partition of the safety monitoring process is reduced.

Switching the time partition for each carrier interruption as in the technique disclosed in Patent Literature 1 increases a switching frequency of the time partition, and increases CPU overhead.

Whereas, if the carrier interruptions are thinned out to such an extent that the switching frequency of the time partition does not cause a problem, an activation cycle of the control process becomes long, which causes trouble in the control process.

Further, the technique disclosed in Patent Literature 1 can be applied only in a case where an interruption from the control process is a periodic interruption like a carrier interruption.

An object of the present invention is to prevent a determination that an abnormality has occurred in a device, due to detection of a violation in a time partition of a process other than the safety monitoring process, although a CPU time of the safety monitoring process is ensured.

### Solution to Problem

A control apparatus according to the present invention includes:

a monitoring unit to perform first monitoring that is monitoring according to a first monitoring rule, when a control interruption that triggers priority control occurs in a first time partition that is one time partition among a plurality of time partitions included in one cycle, the first time partition being a time partition for execution of general control, and perform a second monitoring that is monitoring according to a second monitoring rule, when the control interruption occurs in a second time partition that is one time partition among the plurality of time partitions, the second time partition being a time partition for execution of safety monitoring that monitors presence or absence of an occurrence of a failure.

### Advantageous Effects of Invention

According to the present invention, since a monitoring rule for a time partition (first time partition) of a process other than a safety monitoring process is used, it is possible to prevent detection of a violation in a time partition of a process other than the safety monitoring process. Therefore, it is possible to prevent determination that an abnormality has occurred in the device although a CPU time of the safety monitoring process is ensured.

### BRIEF DESCRIPTION OF DRAWINGS

FIG. 1 is a configuration diagram of a control apparatus 100 in a first embodiment.

FIG. 2 is a configuration diagram of a microcontroller 200 in the first embodiment.

FIG. 3 is a configuration diagram of a processor 201 in the first embodiment.

FIG. 4 is a configuration diagram of a host OS 220 in the first embodiment.

FIG. 5 is a configuration diagram of a guest OS 230 in the first embodiment.

FIG. 6 is a conceptual view of partitioning in the first embodiment.

FIG. 7 is a conceptual view of a schedule table 224 in the first embodiment.

FIG. 8 is a configuration view of a first monitoring table 2291 in the first embodiment.

FIG. 9 is a flowchart of a TP switching process in the first embodiment.

FIG. 10 is a flowchart of a control interruption process in the first embodiment.

FIG. 11 is a flowchart of a first expiration interruption process in the first embodiment.

FIG. 12 is a flowchart of a VM task process in the first embodiment.

FIG. 13 is a flowchart of a safety monitoring task process in the first embodiment.

FIG. 14 is a configuration diagram of a host OS 220 in a second embodiment.

FIG. 15 is a configuration view of a second monitoring table 2292 in the second embodiment.

FIG. 16 is a view illustrating setting of a first monitoring table 2291 in the second embodiment.

FIG. 17 is a flowchart of a TP switching process in the second embodiment.

FIG. 18 is a flowchart of the TP switching process in the second embodiment.

FIG. 19 is a flowchart of the TP switching process in the second embodiment.

FIG. 20 is a flowchart of a second expiration interruption process in the second embodiment.

FIG. 21 is a configuration view of a second monitoring table 2292 in a third embodiment.

FIG. 22 is a view illustrating setting of a first monitoring table 2291 in the third embodiment.

FIG. 23 is a flowchart of a TP switching process in the third embodiment.

FIG. 24 is a flowchart of the TP switching process in the third embodiment.

FIG. 25 is a flowchart of the TP switching process in the third embodiment.

FIG. 26 is a hardware configuration diagram of a control apparatus 100 in embodiments.

### DESCRIPTION OF EMBODIMENTS

In embodiments and the drawings, the same elements or mutually corresponding elements are denoted by the same reference numerals. The description of the elements denoted by the same reference numerals will be omitted or simplified appropriately. Arrows in the figures mainly indicate a data flow or a processing flow.

### First Embodiment

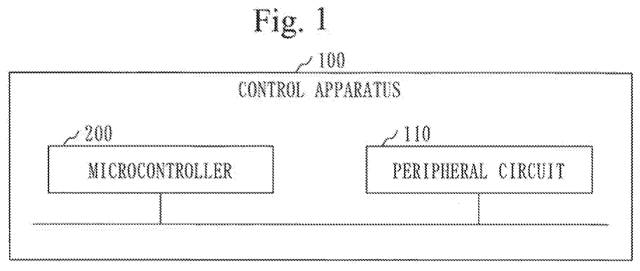

An aspect of performing various controls while performing safety monitoring will be described with reference to FIGS. 1 to 13.

Description of Configuration

A configuration of a control apparatus 100 will be described with reference to FIG. 1.

The control apparatus 100 includes a microcontroller 200 and a peripheral circuit 110.

The microcontroller 200 is a computer provided in the control apparatus 100.

The peripheral circuit 110 is a peripheral circuit connected to the microcontroller 200.

For example, the peripheral circuit 110 is a sensor, an actuator, and the like.

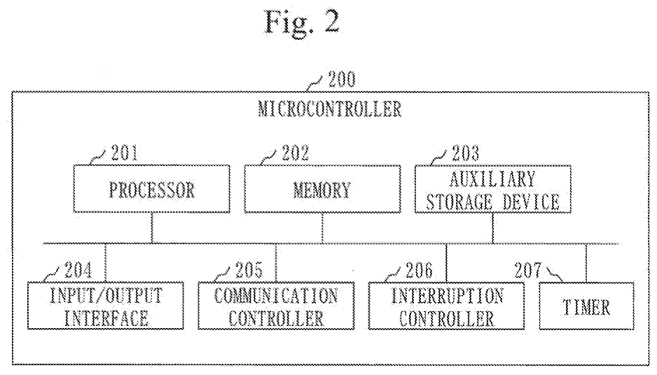

A configuration of the microcontroller 200 will be described with reference to FIG. 2.

The microcontroller 200 includes hardware such as a processor 201, a memory 202, an auxiliary storage device 203, an input/output interface 204, a communication controller 205, an interruption controller 206, and a timer 207. These pieces of hardware are connected to each other via a signal line.

The processor 201 is, for example, a CPU.

The memory 202 is a volatile storage device. Specifically, the memory 202 is a random access memory (RAM).

The auxiliary storage device 203 is a non-volatile storage device. For example, the auxiliary storage device 203 is a read only memory (ROM) or a flash memory.

The input/output interlace 204 is connected with a sensor, an actuator, and the like. The input/output interface 204 includes an AD converter to obtain a sensor value, a PWM circuit to control an actuator, and the like. AD is an abbreviation for analog to digital, and PWM is an abbreviation for pulse width modulation.

The communication controller 205 is a communication device that functions as a transmitter and a receiver. The communication controller 205 includes a CAN controller, an SPI controller, and the like. CAN is an abbreviation for controller area network, and SPI is an abbreviation for serial peripheral interface.

The interruption controller 206 is a controller to control an interruption.

The timer 207 is an element to detect lapse of a set time.

The microcontroller 200 has a virtualization support function.

The microcontroller 200 has an instruction to switch a privileged mode of the processor 201.

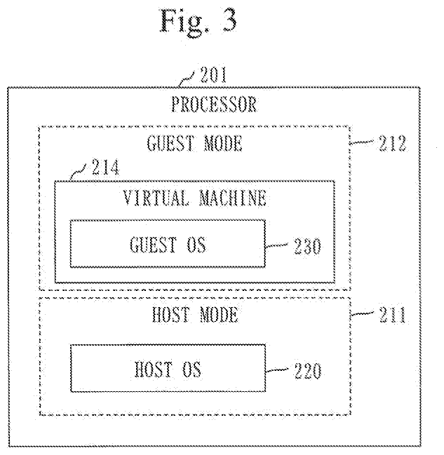

A configuration of the processor 201 will be described with reference to FIG. 3.

The processor 201 operates in a host mode 211 or a guest mode 212.

The host mode 211 and the guest mode 212 are privileged modes of the processor 201.

The host mode 211 is a mode for executing a virtual machine monitor.

The guest mode 212 is a mode for executing a virtual machine 214.

In the host mode 211, the processor 201 functions as a host OS 220. The host OS 220 serves as a virtual machine monitor.

The host OS 220 is an operating system (OS) in the host mode 211.

The virtual machine monitor controls the virtual machine 214. The virtual machine monitor is called VMM.

In the guest mode 212, the processor 201 functions as the virtual machine 214.

The virtual machine 214 is a computer virtually constructed by software. The virtual machine 214 is called VM.

The OS in the virtual machine 214 is called a guest OS 230.

The host OS 220 operates in the host mode 211 and can access all the hardware resources of the microcontroller 200.

The guest OS 230 operates in the guest mode 212 and cannot access (he hardware resources used by the host OS 220.

When the control apparatus 100 is an in-vehicle control apparatus, an AUTOSAR OS is used as the guest OS 230. AUTOSAR is an abbreviation of automotive open system architecture.

The microcontroller 200 has a function of dividing hardware resources such as the memory 202, the input/output interface 204, and the interruption controller 206. Further, the microcontroller 200 has a function of exclusively or sharedly assigning hardware resources to the virtual machine 214 and the host OS 220.

The virtual machine 214 operates using the assigned hardware resources. For example, when an interruption to the virtual machine 214 occurs while the virtual machine 214 is being executed, transition to the host mode is not performed, and the interruption is directly accepted in the virtual machine 214. Further, when an interruption to another virtual machine occurs, the interruption is suspended. Further, when an interruption to the host OS 220 occurs while the virtual machine 214 is being executed, the execution of the virtual machine 214 is interrupted, transition to the host mode is performed, and the host OS 220 accepts the interruption.

The host OS 220 is executed by the processor 201 to provide a task management function, a task scheduling function, an interruption management function, a time management function, a resource management function, and the like.

The host OS 220 has a function of spatially and temporally protecting divided hardware resources, as a function related to securing security.

For example, spatial protection is protection of the memory 202 by a memory protection unit (MPU) that is part of the processor 201, protection of the input/output interface 204 by a peripheral protection function provided to the microcontroller 200, and the like.

For example, temporal protection is realized by partitioning on an execution time of the processor 201, monitoring of a control interruption, or the like.

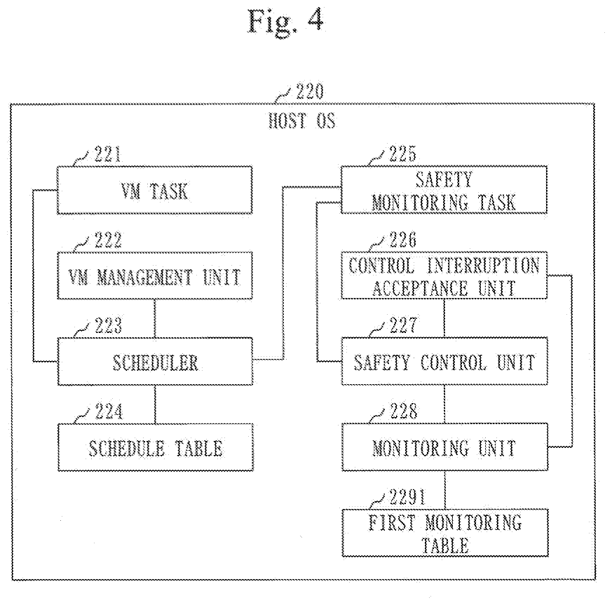

A configuration of the host OS 220 will be described with reference to FIG. 4.

The host OS 220 includes a VM task 221, a VM management unit 222, a scheduler 223, a schedule table 224, a safety monitoring task 225, a control interruption acceptance unit 226, a safety control unit 227, a monitoring unit 228, and a first monitoring table 2291.

The VM task 221 is a task for executing the virtual machine 214.

The VM management unit 222 serves as a virtual machine monitor to manage the virtual machine 214. Specifically, the VM management unit 222 assigns hardware resources to the virtual machine 214, switches the privileged mode, saves and restores contexts of the virtual machine 214, and the like.

The scheduler 223 uses the schedule table 224 to perform partitioning on an execution time of the processor 201 and scheduling of tasks that operate on the host OS 220. For example, scheduling is assignment of an execution time.

The schedule table 224 is a table indicating time partitions and task schedules.

The safety monitoring task 225 is a task for executing safety monitoring. Safety monitoring is a process for monitoring the presence or absence of an occurrence of a failure. For example, safety monitoring is a process called failure diagnosis and a process called abnormality monitoring.

The control interruption acceptance unit 226 accepts a control interruption. The control interruption is an interruption that triggers priority control. Priority control will be described later.

The safety control unit 227 performs safety control. Safety control is a process for when a failure occurs. For example, the safety control is a fail-safe process or a tail operation process.

The monitoring unit 228 performs monitoring in accordance with a monitoring rule that is set in the first monitoring table 2291.

The first monitoring table 2291 is a table in which a monitoring rule for each time partition is set.

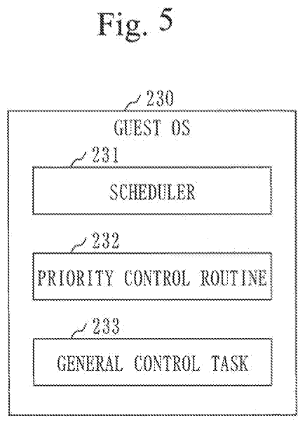

A configuration of the guest OS 230 will be described with reference to FIG. 5.

The guest OS 230 includes a scheduler 231, a priority control routine 232, and a general control task 233.

The scheduler 231 performs scheduling of tasks that operate on the guest OS 230.

The priority control routine 232 is a routine for priority control. Priority control is control for when a control interruption occurs. Priority control has higher priority than general control and safety monitoring, and is executed prior to general control and safety control. Specifically, the priority control routine 232 is implemented as an interrupt service routine (ISR). In a case where the guest OS 230 is an AUTOSAR OS, the priority control routine 232 can be implemented as a Category 1 ISR.

The general control task 233 is a task for executing general control. General control is control other than priority control.

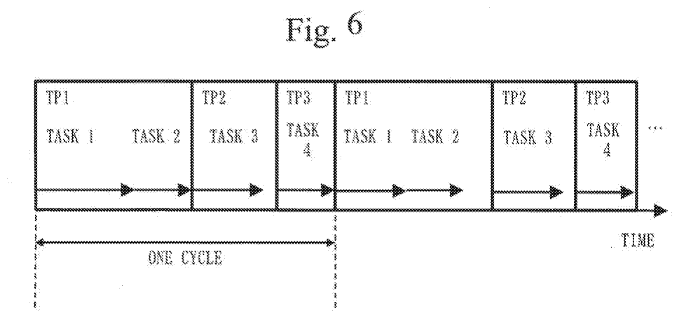

Partitioning by the scheduler 223 will be described with reference to FIG. 6.

A predetermined fixed time is called one cycle.

One cycle is divided into a plurality of time partitions (TP). The time partition is a fixed time in one cycle. In FIG. 6, one cycle is divided into three time partitions.

Each time partition is assigned with one or more tasks.

The scheduler 223 manages a plurality of time partitions for every one cycle, and manages a task for each time partition. When a plurality of tasks is assigned to a time partition, the scheduler 223 performs scheduling on the plurality of tasks on the basis of the respective priorities of the plurality of tasks.

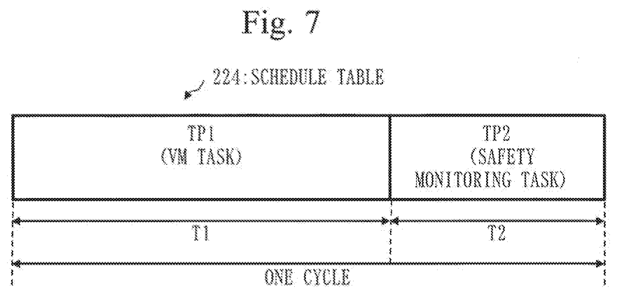

A specific example of contents that are set in the schedule table 224 wilt be described with reference to FIG. 7.

In the schedule table 224, a first time partition and a second time partition are set as a plurality of time partitions included in one cycle.

The first time partition (TP1) is a time partition assigned with the VM task 221. A length of the first time partition is T1.

The VM task is a task for executing the virtual machine 214.

The second time partition (TP2) is a time partition assigned with the safety monitoring task 225. A length of the second time partition is T2.

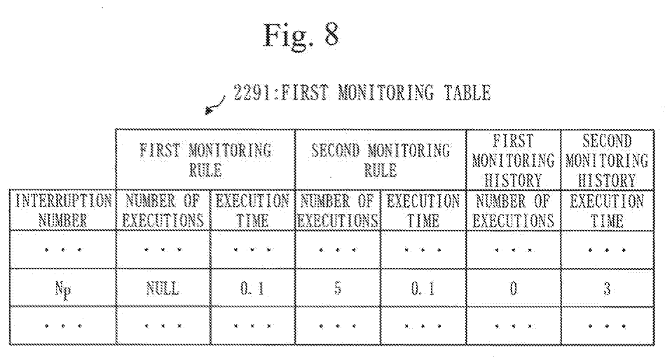

A configuration of the first monitoring table 2291 will be described with reference to FIG. 8.

The first monitoring table 2291 has individual fields of an interruption number, a first monitoring rule, a second monitoring rule, a first monitoring history, and a second monitoring history.

The field of the interruption number indicates an interruption number, which is a number identifying an interruption.

The interruption number N_{P} is a number identifying a control interruption.

The field of the first monitoring rule indicates a first monitoring rule, which is a monitoring rule in the first time partition.

When a control interruption occurs in the first time partition, the monitoring unit 228 performs first monitoring. The first monitoring is monitoring according to the first monitoring rule.

Specifically, the first monitoring rule is a rule that limits an execution time of priority control in the first time partition. The monitoring unit 228 monitors, as the first monitoring, an execution time of priority control in the first time partition.

If a violation of the first monitoring rule occurs in the first time partition, the safety control unit 227 performs safety control.

The field of the second monitoring rule indicates a second monitoring rule, which is a monitoring rule in the second time partition.

When a control interruption occurs in the second time partition, the monitoring unit 228 performs second monitoring. The second monitoring is monitoring according to She second monitoring rule.

Specifically, the second monitoring rule is a rule that limits a number of executions and an execution time of priority control in the second time partition. The monitoring unit 228 monitors, as the second monitoring, the number of executions and an execution time of the priority control in the second time partition.

If a violation of the second monitoring rule occurs in the second time partition, the safety control unit 227 performs safety control.

The field of the first monitoring rule and the field of the second monitoring rule each include a field of a number of executions and a field of an execution time.

The field of the number of executions indicates an upper limit of the number of times priority control is executed. NULL in the field of the number of executions means that monitoring of the number of executions is unnecessary.

The field of the execution time indicates an upper limit of a time during which priority control is executed.

The field of the first monitoring history indicates a number of executions of priority control in the hist time partition.

The field of the second monitoring history indicates a number of executions of priority control in the second time partition.

Description of Operation

An operation of the control apparatus 100 corresponds to a control method. Further, a procedure of the control method corresponds to a procedure of a control program.

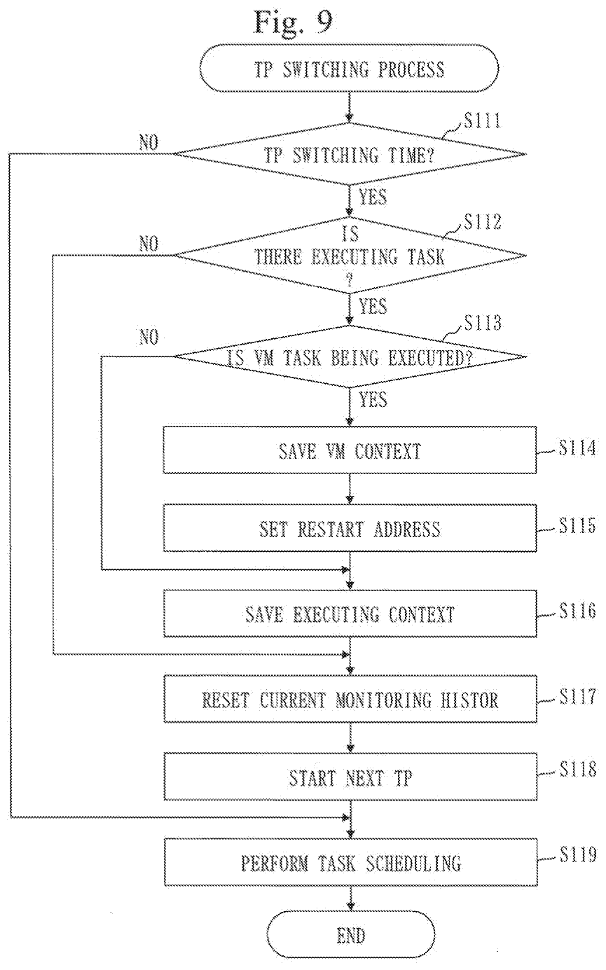

A TP switching process will be described with reference to FIG. 9.

The TP switching process is a process for switching time partitions.

The TP switching process is executed by the scheduler 223 at each tick interruption of the host OS 220.

In step S111, the scheduler 223 determines whether the current time is a TP switching time. The TP switching time is a time at which a time partition is switched.

Specifically, the scheduler 223 refers to an assigned time of the current time partition that is set in the schedule table 224, and determines whether an execution time of the current time partition has exceeded the assigned time of the current time partition. When the execution time of the current time partition exceeds the assigned time of the current time partition, the current time is the TP switching time.

When the current time is the TP switching time, the process proceeds to step S112.

When the current time is not the TP switching time, the process proceeds to step S119.

In step S112, the scheduler 223 determines whether there is an executing task. The executing task is a task that is currently being executed.

When there is an executing task, the process proceeds to step S113.

When there is no executing task, the process proceeds to step S116.

In step S113, the scheduler 223 determines whether the VM task 221 is being executed. That is, the scheduler 223 determines whether the executing task is the VM task 221.

When the VM task 221 is being executed, the process proceeds to step S114.

When the VM task 221 is not being executed, the process proceeds to step S116.

In step S114, the scheduler 223 saves a VM context.

The VM context is a context of the virtual machine 214.

In step S115, the scheduler 223 sets a restart address of the VM task 221.

The restart address of the VM task 221 is an execution address when the VM task 221 is restarted.

The execution address is an address of a region where an instruction to be executed is stored.

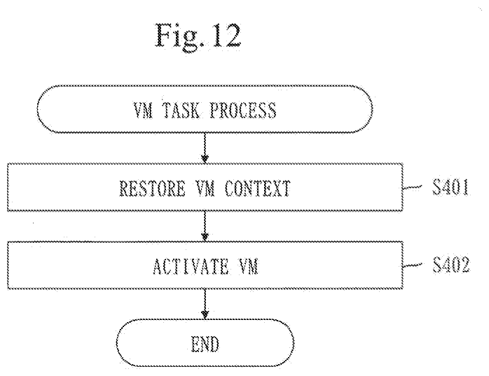

Specifically, the scheduler 223 rewrites a program counter in a task control block (TCB) of the VM task 221 into an execution address immediately before processing of restoring the VM context and activating the virtual machine 214 (execution address immediately before step S401 in FIG. 12).

In step S116, the scheduler 223 saves an executing context. The executing context is a context of the executing task.

In step S117, the scheduler 223 resets a current monitoring history. The current monitoring history is a monitoring history of the current time partition.

Specifically, the scheduler 223 selects a monitoring history of the current time partition from the first monitoring table 2291, and updates, to zero, the number of executions that is set in the selected monitoring history.

In step S118, the scheduler 223 refers to the schedule table 224 to determine the next time partition, and starts the next time partition.

In step S119, the scheduler 223 performs task scheduling on the next time partition.

Specifically, the scheduler 223 refers to a task schedule of the next time partition that is set in the schedule table 224, and performs task scheduling in accordance with the referred task schedule.

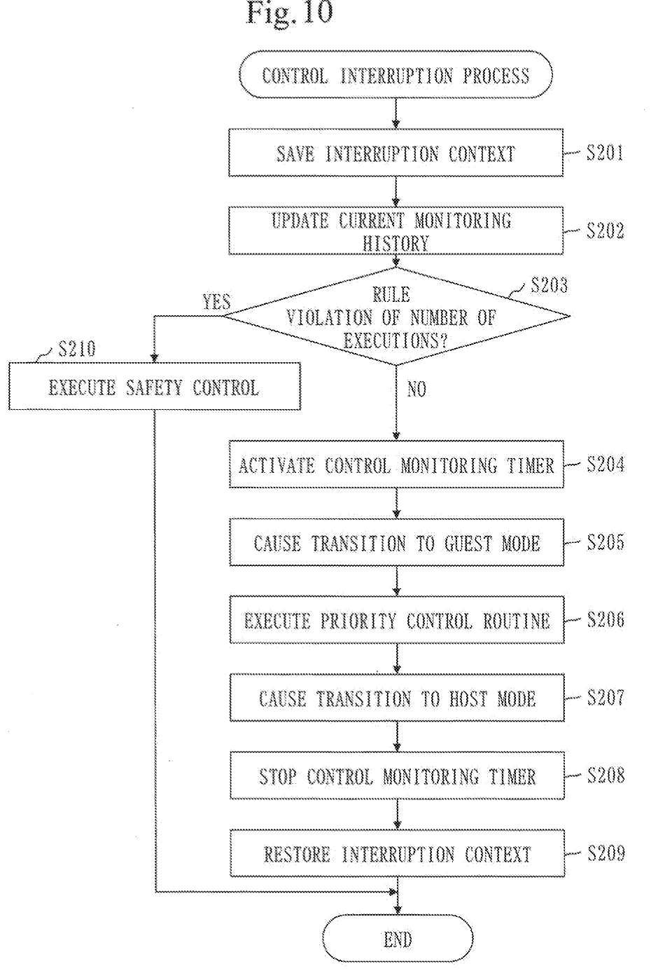

A control interruption process will be described with reference to FIG. 10.

The control interruption process is a process for when a control interruption occurs.

The control interruption process is executed when the control interruption acceptance unit 226 accepts a control interruption.

In step S201, the control interruption acceptance unit 226 saves an interruption context. The interruption context is a context of an interruption task. The interruption task is a task that has been executed when the control interruption occurred.

In step S202, the control interruption acceptance unit 226 calls the monitoring unit 228, and the monitoring unit 228 updates the current monitoring history.

Specifically, the monitoring unit 228 selects a monitoring history of the current time partition from the first monitoring table 2291, and adds 1 to the number of executions that is set in the selected monitoring history.

In step S203, the monitoring unit 228 determines whether a rule violation of the number of executions has occurred.

Specifically, the monitoring unit 228 performs the determination as follows.

First, the monitoring unit 228 acquires, from the first monitoring table 2291, the number of executions that is set in the monitoring rule of the current time partition and the number of executions that is set in the monitoring history of the current time partition.

Next, the monitoring unit 228 compares the number of executions in the monitoring history with the number of executions in the monitoring rule. However, if the number of executions in the monitoring role is NULL, the monitoring unit 228 does not compare the number of executions in the monitoring history with the number of executions of the monitoring rule.

When the number of executions in the monitoring history is greater than the number of executions in the monitoring rule, the monitoring unit 228 determines that a rule violation of the number of executions has occurred.

When the number of executions in the monitoring history is equal to or less than the number of executions in the monitoring rule, the monitoring unit 228 determines that a rule violation of the number of executions has not occurred. Further, when the number of executions in the monitoring rule is NULL, the monitoring unit 228 determines that the rule violation of the number of executions has not occurred.

When the rule violation of the number of executions has occurred, the process proceeds to step S210.

When the rule violation of the number of executions has not occurred, the process proceeds to step S204.

In step S204, the monitoring unit 228 activates a control monitoring timer. The control monitoring timer is a timer for monitoring of an execution time of priority control.

Specifically, the monitoring unit 228 acquires, from the first monitoring table 2291, the execution time that is set in the monitoring rule of the current time partition, sets the acquired execution time in the timer, and activates the timer. The timer to be activated is the control monitoring timer.

In step S205, the control interruption acceptance unit 226 causes transition of the privileged mode of the processor 201 from the host mode to the guest mode.

In step S206, the virtual machine 214 executes the priority control routine 232 from the beginning of the priority control routine 232 in the guest mode.

In step S207, the virtual machine 214 causes transition of the privileged mode of the processor 201 from the guest mode to the host mode.

Specifically, the virtual machine 214 causes transition of the privileged mode of the processor 201 from the guest mode to the host mode, by executing a transition instruction included in the priority control routine 232.

In step S208, the monitoring unit 228 stops the control monitoring timer.

In step S209, the control interruption acceptance unit 226 restores the interruption context.

After step S209, the task that has been executed when the control interruption occurs is restarted.

In step S210, the control interruption acceptance unit 226 calls the safety control unit 227, and the safety control unit 227 executes safety control.

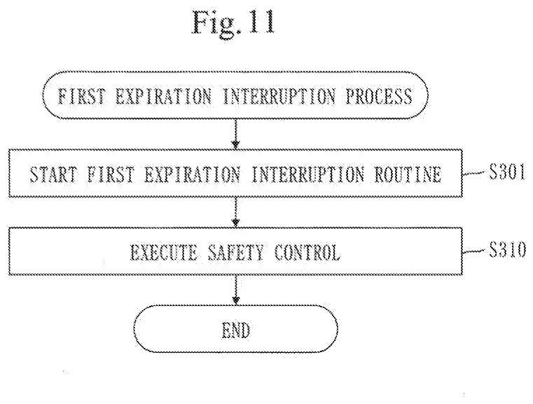

A first expiration interruption process will be described with reference to FIG. 11.

The first expiration interruption process is a process for when a first expiration interruption occurs. The first expiration interruption is an interruption that occurs when the control monitoring timer activated in step S204 (see FIG. 10) has expired. Expiration of the control monitoring timer means that a rime that is set in the control monitoring timer has elapsed.

The first expiration interruption process is executed when the monitoring unit 228 accepts the first expiration interruption.

In step S301, the monitoring unit 228 starts execution of a first expiration interruption routine. The first expiration interruption routine is implemented as part of the monitoring unit 228.

In step S310, the monitoring unit 228 calls the safety control unit 227, and the safety control unit 227 executes safety control. Specifically, the monitoring unit 228 calls the safety control unit 227 by executing a calling instruction included in the first expiration interruption routine.

The VM task process will be described with reference to FIG. 12.

The VM task process is a process to be executed by the VM task 221.

In step S401, the VM task 221 restores the VM context.

In step S402, the VM task 221 activates the virtual machine 214. Specifically, the VM task 221 causes transition of the privileged mode of the processor 201 from the host mode to the guest mode by a transition instruction. Thus, the virtual machine 214 is activated.

When the VM task 221 is interrupted by the scheduler 223 while the virtual machine 214 is being executed, the scheduler 223 sets a restart address of the VM task 221.

That is, execution of the virtual machine 214 is also interrupted when the VM task 221 is interrupted, and the execution of the virtual machine 214 is also restarted when the VM task 221 is restarted.

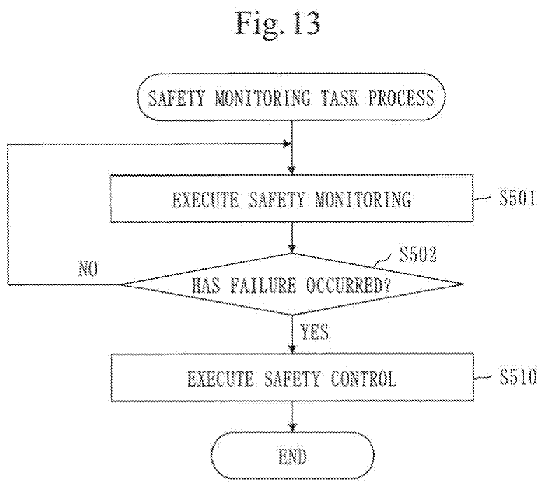

A safety monitoring task process will be described with reference to FIG. 13.

The safety monitoring task process is a process to be executed by the safety monitoring task 225.

In step S501, the safety monitoring task 225 executes safety monitoring.

In step S502, the safety monitoring task 225 determines the presence or absence of occurrence of a failure on the basis of a result of the safety monitoring.

When a failure occurs, the process proceeds to step S510.

When no failure has occurred, the process proceeds to step S501.

In step S510, the safety monitoring task 225 calls the safety control unit 227, and the safety control unit 227 executes safety control.

### Supplement to First Embodiment

The priority control is also called a control process, and the general control is also called a non-control process.

The safety monitoring is also called a safety monitoring process, and the safety control is also called a safety control process.

An application for the control process, an application for the non-control process, an application for the safety monitoring process, and an application for the safety control process are stored in the auxiliary storage device 203, read into the memory 202, and executed by the processor 201. The processor 201 may directly execute the application stored in the auxiliary storage device 203.

The application for the control process is an execution image of a control process. The application for the non-control process is an execution image of the non-control process. The application for the safety monitoring process is an execution image of the safety monitoring process. The application for the safety control process is an execution image of the safety control process.

The priority of each element is set as follows.

The priority of an expiration interruption routine, which is part of the monitoring unit 228, is higher than the priority of the control interruption acceptance unit 226.

The priority of the control interruption acceptance unit 226 is the same as the priority of the priority control routine 232.

The priority of the priority control routine 232 is higher than the priority of the scheduler 223.

The priority of the scheduler 223 is higher than the priority of the safety monitoring task 225.

The priority of the general control task 233 is lower than the priority of the scheduler 223.

A control interruption is an interruption that is out of management by the OS.

The microcontroller 200 includes software elements such as the host OS 220 and the guest OS 230. The software elements are elements implemented by software.

The auxiliary storage device 203 stores a control program for causing a computer to function as the host OS 220 and the guest OS 230. T his control program is loaded into the memory 202 and executed by the processor 201. The processor 201 may directly execute the control program stored in the auxiliary storage device 203.

The microcontroller 200 may include a plurality of processors substituting for the processor 201. The plurality of processors shares the role of the processor 201.

The control program can be stored in a non-volatile storage medium such as a magnetic disk, an optical disk, a flash memory, or the like in a computer readable manner. The non-volatile storage medium is a non-transitory tangible medium.

### Effect of First Embodiment

According to the first embodiment, it is possible to realize ensuring of a CPU time of the safety monitoring process and suppression of delay of the control process, while suppressing unnecessary abnormality detection and CPU overhead.

In the first embodiment, the monitoring rule of the control interruption is switched in accordance with switching of a time partition. This makes it possible to solve the problems of Patent Literature 2 and Patent Literature 3. That is, it becomes possible to solve the problem that it is determined that an abnormality has occurred in a device as a result of detection of a violation in a time partition of a process other than the safety monitoring process, although a CPU time of the safety monitoring process is ensured and there is no problem in the device.

Further, since the priority control routine 232 and the control interruption acceptance unit 226 are interruptions that are out of management by the OS, an interruption can be accepted even while interruptions by the guest OS and the host OS are inhibited. Therefore, delay of the priority control can be suppressed.

Further, the priority control routine 232 and the general control task 233 are executed by the virtual machine 214. Therefore, the priority control routine 232 and the general control task 233 can be spatially and temporally independent of the safety monitoring task 225 and the safety control unit 227. This makes it possible to ensure the CPU time of the safety monitoring process. In addition, the priority control routine 232 and the general control task 233 can be developed at a safety level lower than a safety level required for the safety monitoring task 225 and the safety control unit 227.

### Second Embodiment

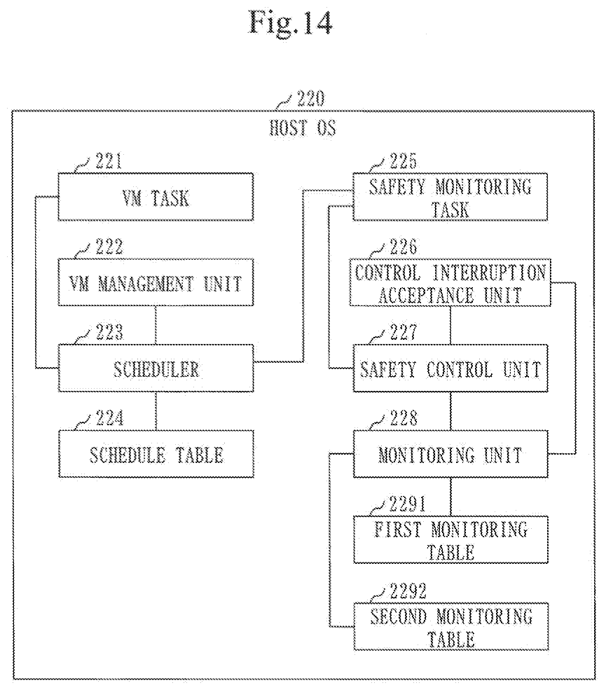

Regarding an aspect of monitoring an execution time of a first time partition instead of monitoring an execution time of priority control in the first time partition, points different from the first embodiment will be mainly described with reference to FIGS. 14 to 20.

Description of Configuration

A configuration of a host OS 220 will be described with reference to FIG. 14.

The host OS 220 includes a second monitoring table 2292 in addition to the elements described in the first embodiment (see FIG. 4).

The second monitoring table 2292 is a table in which a monitoring rule for each time partition is set.

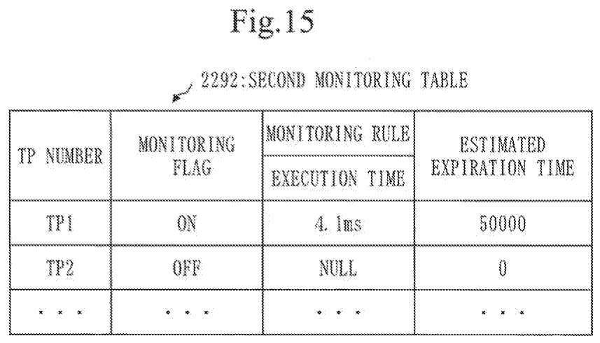

A configuration of the second monitoring table 2292 will be described with reference to FIG. 15.

The second monitoring table 2292 has individual fields of a TP number, a monitoring flag, a monitoring rule, and an estimated expiration time.

The field of the TP number indicates a TP number, which is a number identifying a time partition.

The field of the monitoring flag indicates a value of a monitoring flag, which is a flag indicating necessity of safety monitoring.

When a value of the monitoring flag is ON, safety monitoring is required.

When a value of the monitoring flag is OFF, safety monitoring is not required.

The field of the monitoring role indicates a monitoring rule for each time partition. Specifically, the field of the monitoring rule indicates an upper limit of an execution time of a time partition, for each time partition.

The monitoring rule associated with TP1 is a first monitoring rule.

The first monitoring rule is a rule that limits an execution time of a first time partition.

An execution time of the first time partition is a time obtained by adding an execution time of general control in the first time partition and an execution time of priority control in the first time partition.

The monitoring rule associated with TP2 is a second monitoring rule.

Since the second monitoring rule is NULL, there is no monitoring rule for an execution time of a second time partition.

The field of the estimated expiration time indicates an estimated expiration time of a time partition.

The estimated expiration time is a time when an assigned time of a time partition (execution time of general control) has elapsed from a start time of the time partition.

When a value of the monitoring flag is OFF, the estimated expiration time is zero.

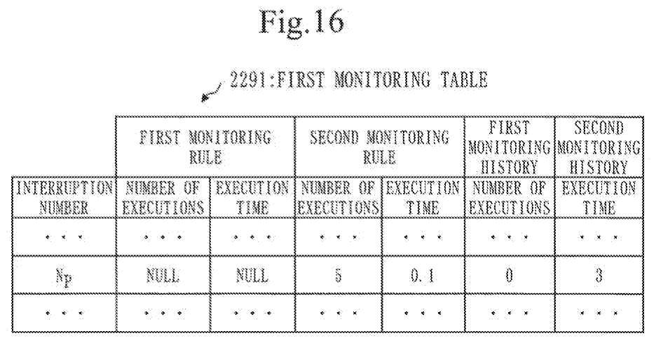

Setting of a first monitoring table 2291 will be described with reference to FIG. 16.

A number of executions and an execution time are NULL in the first monitoring rule. Therefore, there is no monitoring rule in priority control in the first time partition.

On the basis of the second monitoring table 2292 of FIG. 15, a monitoring unit 228 monitors an execution time of the first time partition, as first monitoring.

On the basis of the first monitoring table 2291 of FIG. 16, the monitoring unit 228 monitors a number of executions and an execution time of priority control in the second time partition, as the second monitoring.

Description of Operation

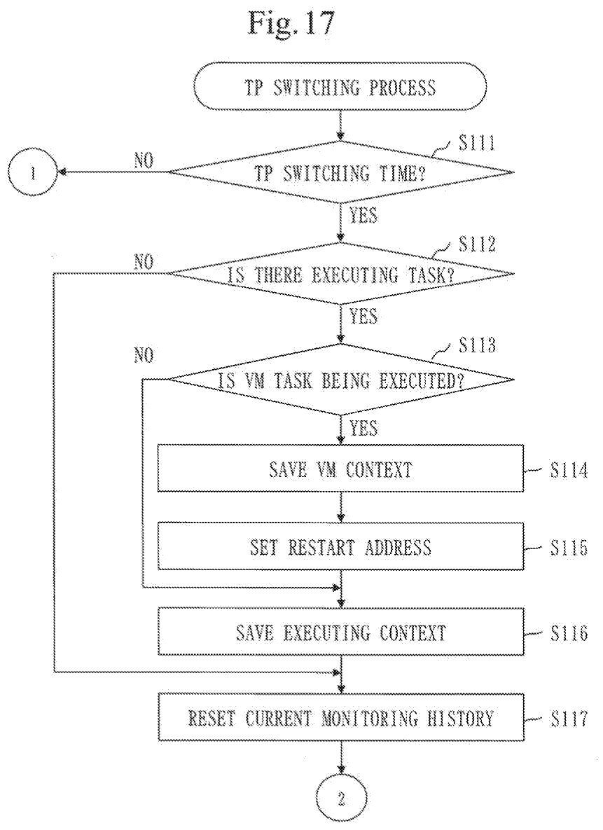

ATP switching process will be described with reference to FIGS. 17, 18, and 19.

In FIG. 17, processing from step S111 to step S117 is as described in the first embodiment (see FIG. 9).

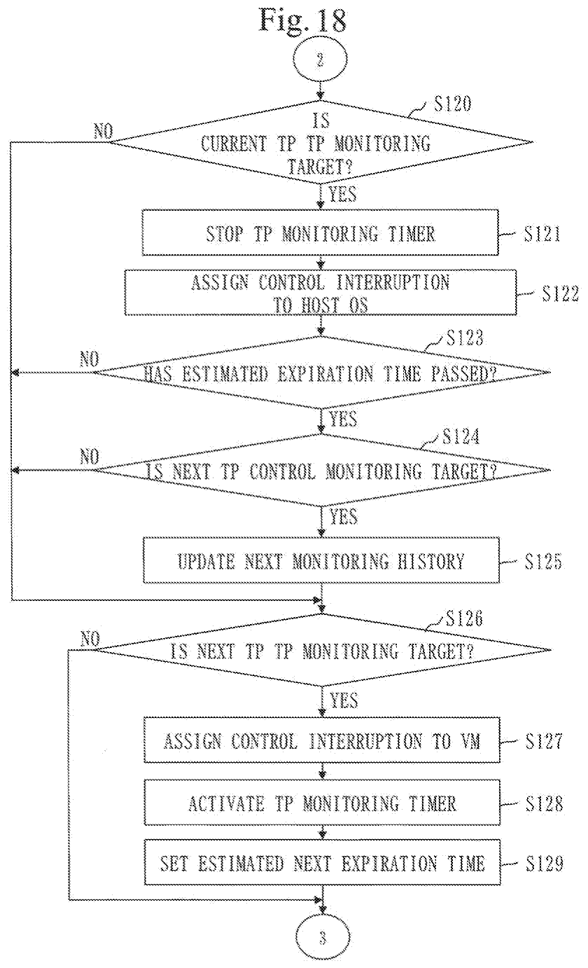

After step S117, the process proceeds to step S120 (see FIG. 18).

In step S120 (see FIG. 18), a scheduler 223 determines whether the current time partition is a TP monitoring target. The TP monitoring target is a time partition to be monitored for an execution time of a time partition.

Specifically, the scheduler 223 selects a monitoring flag of the current time partition from the second monitoring table 2292, and determines whether a value of the selected monitoring flag is ON.

When the current time partition is the TP monitoring target, the process proceeds to step S121.

When the current time partition is not the TP monitoring target, the process proceeds to step S126.

In step S121, a TP monitoring timer for the current time partition is operating. The TP monitoring timer is a timer for monitoring of an execution time of a time partition.

The scheduler 223 stops the TP monitoring timer of the current time partition.

In step S122, a control interruption is assigned to a virtual machine 214.

The scheduler 223 calls a VM management unit 222, and the VM management unit 222 assigns a control interruption to the host OS 220. After the control interruption is assigned to the host OS 220, the control interruption is accepted by the host OS 220.

In step S123, the scheduler 223 calls the monitoring unit 228, and the monitoring unit 228 determines whether an estimated expiration time has passed.

That is, the monitoring unit 228 determines whether as assigned time of the first time partition (execution time of general control) has elapsed.

Specifically, the monitoring unit 228 performs the determination as follows.

First, the monitoring unit 228 acquires an estimated expiration time of the current time partition from the second monitoring table 2292.

Then, the monitoring unit 228 compares the current time with the estimated expiration time of the current time partition.

When the estimated expiration time has passed, the process proceeds to step S124.

When the estimated time has not passed, the process proceeds to step S126.

In step S124, the scheduler 223 determines whether the next time partition is a control monitoring target. The control monitoring target is a time partition to be monitored for priority control in the time partition.

Specifically, the scheduler 223 performs the determination as follows.

First, the scheduler 223 specifies the next time partition by referring to a schedule table 224.

Next, the scheduler 223 selects a monitoring rule of the next time partition from the first monitoring table 2291.

Then, the scheduler 223 determines whether at least one of the numbe of executions or the execution is a value other than NULL in the selected monitoring rule.

When at least one of the number of executions or the execution time is a value other than NULL, the next time partition is the control monitoring target.

When the next time partition is the control monitoring target, the process proceeds to step S125.

When the next time partition is not the control monitoring target, the process proceeds to step S126.

In step S125, the scheduler 223 calls the monitoring unit 228, and the monitoring unit 228 updates a next monitoring history. The next monitoring history is a monitoring history of the next time partition.

Specifically, the monitoring unit 228 selects a monitoring history of the next time partition from the first monitoring table 2291, and adds 1 to the number of executions that is set in the selected monitoring history.

In step S126, the scheduler 223 determines whether the next time partition is the TP monitoring target.

Specifically, the scheduler 223 selects a monitoring flag of the next time partition from the second monitoring table 2292, and determines whether a value of the selected monitoring flag is ON.

When the next time partition is the TP monitoring target, the process proceeds to step S127.

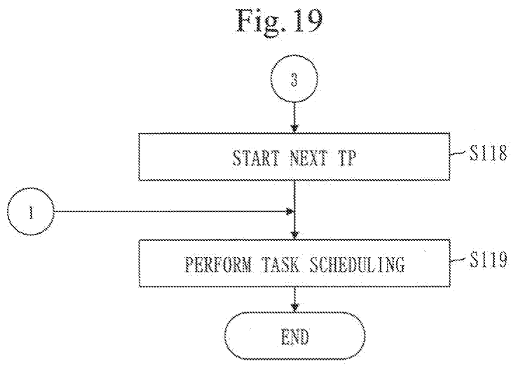

When the next time partition is not the TP monitoring target, the process proceeds to step S118 (see FIG. 19).

In step S127, the scheduler 223 calls the VM management unit 222, and the VM management unit 222 assigns a control interruption to the virtual machine 214. After the control interruption is assigned to the virtual machine 214, the control interruption is accepted at the virtual machine 214.

In step S128, the scheduler 223 activates the TP monitoring timer for the next time partition.

Specifically, the scheduler 223 acquires, from the second monitoring table 2292, the execution time that is set in the monitoring rule of the next time partition, sets the acquired execution time in the timer, and activates the timer. The timer to be activated is the TP monitoring timer for the next time partition.

In step S129, the scheduler 223 calls the monitoring unit 228, and the monitoring unit 228 sets an estimated next expiration time. The estimated next expiration time is an estimated expiration time of the next time partition.

Specifically, the monitoring unit 228 sets an estimated expiration time of the next time partition as follows.

First, the monitoring unit 228 calculates a time at which an assigned time of the next time partition has elapsed from the current time. The calculated time is the estimated expiration time.

Next, the monitoring unit 228 calculates a timer count value corresponding to the estimated expiration time.

Next, the monitoring unit 228 selects, from the second monitoring table 2292, a field of the estimated expiration time of the next time partition.

Then, the monitoring unit 228 sets a timer count value in the selected field of the estimated expiration time.

After step S129, the process proceeds to step S118 (see FIG. 19).

In FIG. 19, steps S118 and S119 are as described in the first embodiment (see FIG. 9).

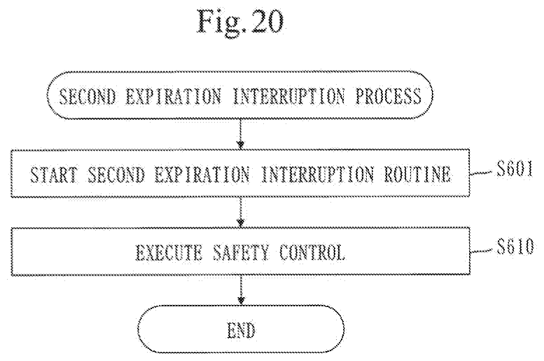

A second expiration interruption process will be described with reference to FIG. 20.

The second expiration interruption process is a process for when a second expiration interruption occurs. The second expiration interruption is an interruption that occurs when the TP monitoring timer activated in step S128 (see FIG. 18) has expired. Expiration of the TP monitoring timer means that a time that is set in the TP monitoring timer has elapsed. That is, the second expiration interruption occurs when a violation of the first monitoring rule occurs in the first time partition.

The second expiration interruption process is executed when the monitoring unit 228 accepts the second expiration interruption.

In step S601, the monitoring unit 228 starts execution of a second expiration interruption routine. The second expiration interruption routine is implemented as part of the monitoring unit 228.

In step S610, the monitoring unit 228 calls a safety control unit 227, and the safety control unit 227 executes safety control. Specifically, the monitoring unit 228 calls the safety control unit 227 by executing a calling instruction included in the second expiration interruption routine.

### Supplement to Second Embodiment

A control interruption its the first time partition is an interruption to be accepted in the guest mode 212.

A control interruption in the second time partition is an interruption to be accepted in the host mode 211.

When an estimated expiration time of a time partition has passed in the first time partition, and when no violation of the first monitoring rule defined in the second monitoring table 2292 occurs in the first time partition, the monitoring unit 228 adds 1 to the number of executions of priority control in the second time partition.

When an estimated expiration time of a time partition has passed in the first time partition, and when a violation of the first monitoring rule defined in the second monitoring table 2292 occurs in the first time partition, the monitoring unit 228 calls the safety control unit 227.

### Effect of Second Embodiment

in the second embodiment, instead of monitoring a number of executions of a control interruption and an execution time of the control interruption, monitoring of an execution time of a time partition is performed. This ensures the execution time of the safety monitoring task 225. In addition, when a control interruption occurs during execution of the virtual machine 214, there is no need to transition to the host mode to enable monitoring of the control interruption by the monitoring unit 228. This also enables the virtual machine 214 to directly accept the control interruption during execution of the virtual machine 214. Therefore, it is possible to suppress execution overhead of the priority control routine 232. Consequently, it is possible to suppress an increase of a CPU load accompanying switching of a context.

In the second embodiment, when the execution time of the time partition for the VM task 221 is extended by the control interruption, the number of executions of the control interruption in the time partition for the safety monitoring task 225 is incremented. That is, when the control interruption that occurs immediately before the end of the VM task 221 extends the time partition for the VM task 221, and the execution time of the time partition for the safety monitoring task 225 is reduced, the number of executions is counted on the assumption that a control interruption has occurred in the time partition for the safety monitoring task 225. This makes it possible to secure the execution time of the safety monitoring task 225 in the time partition for the safety monitoring task 225.

### Third Embodiment

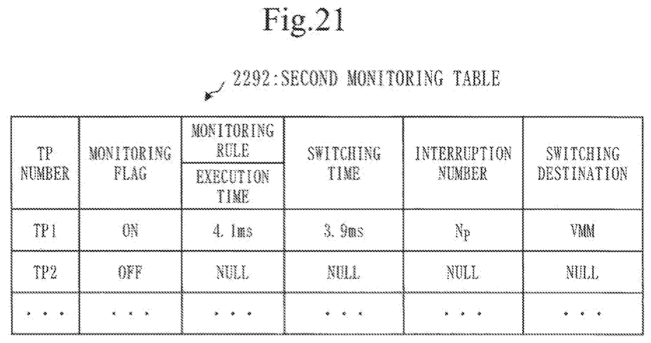

Regarding an aspect of switching an acceptance destination of a control interruption from a guest mode 212 to a host mode 211 at a certain time before a time at which a first time partition is switched to a second time partition, points different from the first embodiment and the second embodiment will be mainly described with reference to FIGS. 21 to 25.

A configuration of a second monitoring table 2292 will be described with reference to FIG. 21.

The second monitoring table 2292 has, instead of the field of the estimated expiration time described in the second embodiment (sec FIG. 15), individual fields of a switching time, an interruption number, and a switching destination.

The field of the switching time indicates a switching time. The switching time is a time to specify a time for switching an acceptance destination of an interruption. Specifically, the field of the switching time indicates an execution time of a time partition at a time of switching.

The field of the interruption number indicates an interruption number, which is a number identifying an interruption. The interruption number N_{P} is an interruption number of a control interruption.

The field of the switching destination indicates a switching destination. The switching destination is an acceptance destination of a control interruption after switching.

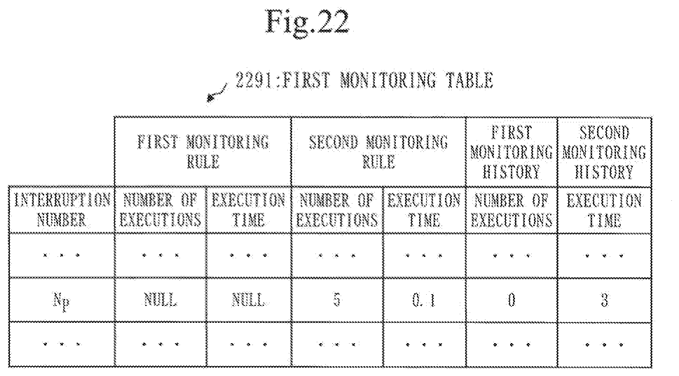

Setting of the first monitoring table 2291 will be described with reference to FIG. 22.

The setting of the first monitoring table 2291 is the same as the setting in the second embodiment (see FIG. 16).

Description of Operation

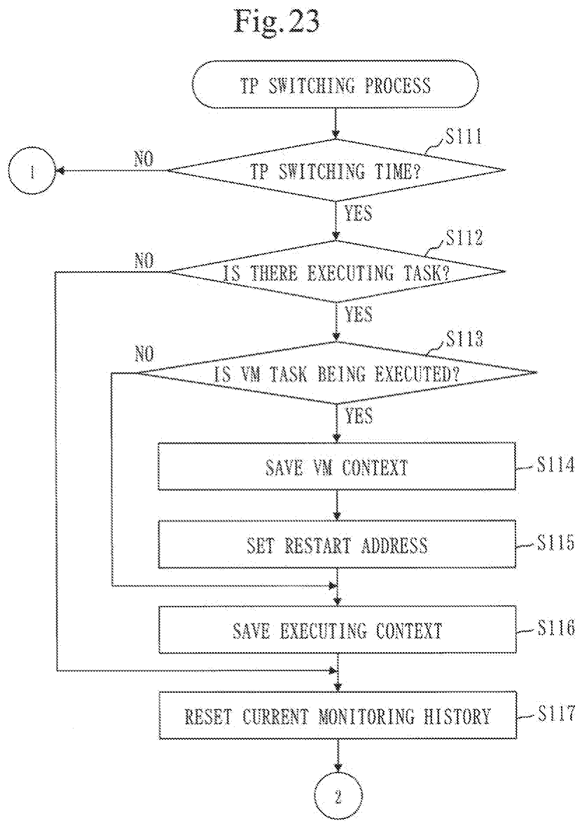

A TP switching process will be described with reference to FIGS. 23, 24, and 25.

In FIG. 23, processing from step S111 to step S117 is as described in the first embodiment (see FIG. 9).

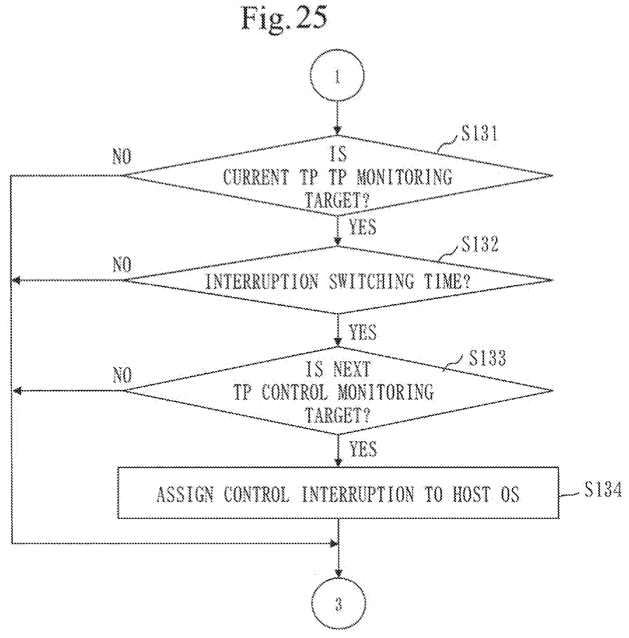

When it is determined in step S111 that the current time is not a TP switching time, the process proceeds to step S131 (see FIG. 25).

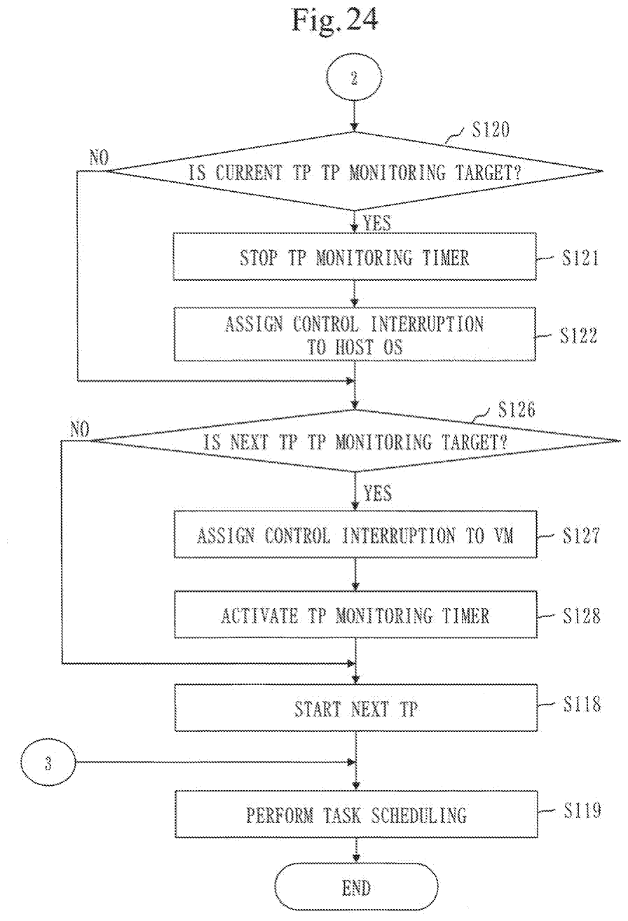

After step S117, the process proceeds to step S120 (see FIG. 24).

In FIG. 24, processing from step S120 to step S122 and processing from step S126 to step S128 are as described in the second embodiment (see FIG. 18).

Further, steps S118 and S119 are as described in the first embodiment (see FIG. 9).

In step S131 (see FIG. 25), a scheduler 223 determines whether the current time partition is a TP monitoring target. A determination method is the same as the method described in step S120 (sec FIG. 18) in the second embodiment.

When the current time partition is the TP monitoring target, the process proceeds to step S132.

When the current time partition is not the TP monitoring target, the process proceeds to step S119 (see FIG. 24).

In step S132, the scheduler 223 determines whether the current time is an interruption switching time. The interruption switching time is a time at which an interruption destination of the control interruption is switched.

Specifically, the scheduler 223 acquires a switching time of the current time partition from the second monitoring table 2292, and determines whether an execution time of the current time partition has exceeded the switching time of the current time partition. When the execution time of the current time partition exceeds the switching time of the current time partition, the current time is the interruption switching time.

When the current time is the interruption switching time, the process proceeds to step S133.

When the current time is not the interruption switching time, the process proceeds to step S119 (see FIG. 24).

In step S133, the scheduler 223 determines whether the next time partition is the control monitoring target. A determination method is the same as the method described in step S124 (see FIG. 18) in the second embodiment.

When the next time partition is the control monitoring target, the process proceeds to step S134.

When the next time partition is not the control monitoring target, the process proceeds to step S119 (see FIG. 24).

In step S134, the scheduler 223 calls a VM management unit 222, and the VM management unit 222 assigns a control interruption to the host OS.

### Supplement to Third Embodiment

A control interruption in the first time partition is an interruption to be accepted in the guest mode 212 except for a certain time before the end of the first time partition.

A control interruption at the certain time of the first time partition is an interruption to be accepted in the host mode 211.

A control interruption in the second time partition is an interruption to be accepted in the host mode 211.

### Effect of Third Embodiment

In the third embodiment, the end time of the time partition is advanced for an amount of the worst execution time of the control interruption, and an allocation destination of the control interruption is changed from she virtual machine 214 to the host OS 220. As a result, when the time partition for the VM task 221 is extended by the control interruption that occurs immediately before the end of the time partition for the VM task 221, and the execution time of the time partition for the safety monitoring task 225 is reduced, the number of executions is counted on the assumption that a control interruption has occurred in the time partition for the safety monitoring task 225. As a result, in the time partition for the safety monitoring task 225, the execution time of the safety monitoring task 225 can be secured.

### Supplement to Embodiments

In an embodiment, a function of the control apparatus 100 may be realized by hardware.

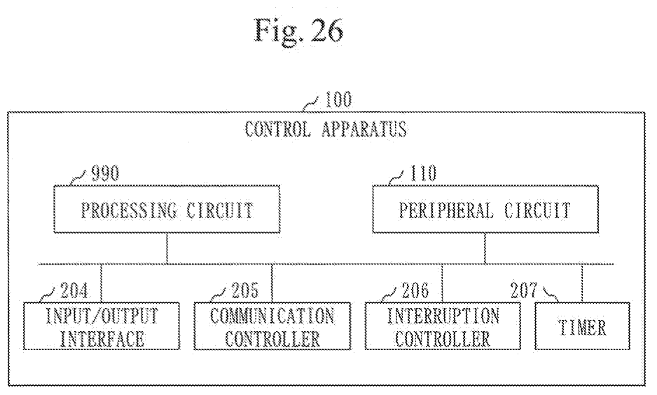

FIG. 26 illustrates a configuration in a case where the function of the control apparatus 100 is realized by hardware.

The control apparatus 100 includes a processing circuit 990. The processing circuit 990 is also referred to as a processing circuitry.

The processing circuit 990 is a dedicated electronic circuit to realize the processor 201, the memory 202, and the auxiliary storage device 203.

For example, the processing circuit 990 is a single circuit, a composite circuit, a programmed processor, a parallel-programmed processor, a logic 1C, a GA, an ASIC, an FPGA, or combination of these. GA is an abbreviation for Gate Array, ASIC is an abbreviation for Application Specific Integrated Circuit, and FPGA is an abbreviation for Field Programmable Gate Array.

The control apparatus 100 may include a plurality of processing circuits substituting for the processing circuit 990. The plurality of processing circuits shares the role of the processing circuit 990.

The embodiments are examples of preferred aspects and are not intended to limit the technical scope of the present invention. The embodiments may be implemented partially or in combination with other aspects. The procedure described using a flowchart or the like may be changed as appropriate.

### REFERENCE SIGNS LIST

100: control apparatus, 110: peripheral circuit, 200: microcontroller, 201: processor, 202: memory, 203: auxiliary storage device, 204: input/output interface, 205: communication controller, 206: interruption controller, 207: timer, 211: host mode, 212: guest mode, 214: virtual machine, 220: host OS, 221: VM task, 222: VM management unit, 223: scheduler, 224; schedule table, 225: safety monitoring task, 226: control interruption acceptance unit, 227: safety control unit, 228: monitoring unit, 2291: first monitoring table, 2292: second monitoring table, 230: guest OS, 231: scheduler, 232: priority control routine, 233: general control task, 990: processing circuit.

1-10. (canceled)

11. A control apparatus comprising:
processing circuitry
to perform first monitoring that is monitoring according to a first monitoring rule, when a control interruption that triggers priority control occurs in a first time partition that is one time partition among a plurality of time partitions included in one cycle, the first time partition being a time partition for execution of general control, and perform a second monitoring that is monitoring according to a second monitoring rule, when the control interruption occurs in a second time partition that is one time partition among the plurality of time partitions, the second time partition being a time partition for execution of safety monitoring that monitors presence or absence of an occurrence of a failure; and
to perform safety control for when a failure occurs in each of a case where a violation of the first monitoring rule occurs in the first time partition, and a case where a violation of the second monitoring rule occurs in the second time partition.

12. The control apparatus according to claim 11, wherein
the general control and the priority control are processes to be executed in a guest mode, and
the safety monitoring and the safety control are processes to be executed in a host mode.

13. The control apparatus according to claim 11, wherein
the first monitoring rule is a rule that limits an execution time of the priority control in the first time partition,
processing circuitry monitors, as the first monitoring, the execution time of the priority control in the first time partition,
the second monitoring rule is a rule that limits a number of executions and an execution time of the priority control in the second time partition, and
processing circuitry monitors, as the second monitoring, the number of executions and the execution time of the priority control in the second time partition.

14. The control apparatus according to claim 11, wherein
the control interruption is an interruption that is out of management by an operating system, and
the interruption that is out of management is an interruption that can be accepted even while an interruption by the operating system is inhibited.

15. The control apparatus according to claim 11, wherein
the first monitoring rule is a rule that limits an execution time of the first time partition, the execution time being obtained by adding an execution time of the general control in the first time partition and an execution time of the priority control in the first time partition,
processing circuitry monitors the execution time of the first time partition as the first monitoring,
the second monitoring rule is a rule that limits a number of executions of the priority control and an execution time of the priority control in the second time partition, and
processing circuitry monitors, as the second monitoring, the number of executions and the execution time of the priority control in the second time partition.

16. The control apparatus according to claim 15, wherein
the control interruption in the first time partition is an interruption to be accepted in the guest mode directly and not via the host mode, and
the control interruption in the second time partition is an interruption to be accepted in the host mode.

17. The control apparatus according to claim 15, wherein processing circuitry
adds 1 to the number of executions of the priority control in the second time partition when the execution time of the first time partition has elapsed, in the first time partition.

18. The control apparatus according to claim 15, wherein
the control interruption in the first time partition is an interruption to be accepted in the guest mode except for a certain time before an end of the first time partition,
the control interruption at the certain time of the first time partition is an interruption to be accepted in the host mode, and
the control interruption in the second time partition is an interruption to be accepted in the host mode.

19. A non-transitory computer readable medium storing a control program for causing a computer to execute:
a monitoring process of performing first monitoring that is monitoring according to a first monitoring rule, when a control interruption that triggers priority control occurs in a first time partition that is one time partition among a plurality of time partitions included in one cycle, the first time partition being a time partition for execution of general control, and performing a second monitoring that is monitoring according to a second monitoring rule, when the control interruption occurs in a second time partition that is one time partition among the plurality of time partitions, the second time partition being a time partition for execution of safety monitoring that monitors presence or absence of an occurrence of a failure; and
a safety control process of performing safety control for when a failure occurs in each of a case where a violation of the first monitoring rule occurs in the first time partition, and a case where a violation of the second monitoring rule occurs in the second time partition.

20. A control apparatus comprising: processing circuitry to perform first monitoring that is monitoring according to a first monitoring rule, when a control interruption that triggers priority control occurs in a first time partition that is one time partition among a plurality of time partitions included in one cycle, the first time partition being a time partition for execution of general control, and perform a second monitoring that is monitoring according to a second monitoring rule, when the control interruption occurs in a second time partition that is one time partition among the plurality of time partitions, the second time partition being a time partition for execution of safety monitoring that monitors presence or absence of an occurrence of a failure, wherein the first monitoring rule is a rule that limits an execution time of the first time partition, the execution time being obtained by adding an execution time of the general control in the first time partition and an execution time of the priority control in the first time partition,
processing circuitry monitors the execution time of the first time partition as the first monitoring,
the second monitoring rule is a rule that limits a number of executions of the priority control and an execution time of the priority control in the second time partition, and
processing circuitry monitors, as the second monitoring, the number of executions and the execution time of the priority control in the second time partition.

21. A non-transitory computer readable medium storing a control program for causing a computer to execute:
a monitoring process of performing first monitoring that is monitoring according to a first monitoring rule, when a control interruption that triggers priority control occurs in a first time partition that is one time partition among a plurality of time partitions included in one cycle, the first time partition being a time partition for execution of general control, and performing a second monitoring that is monitoring according to a second monitoring rule, when the control interruption occurs in a second time partition that is one time partition among the plurality of time partitions, the second time partition being a time partition for execution of safety monitoring that monitors presence or absence of an occurrence of a failure, wherein
the first monitoring rule is a rule that limits an execution time of the first time partition, the execution time being obtained by adding an execution time of the general control in the first time partition and an execution time of the priority control in the first time partition,
the monitoring process includes monitoring the execution time of the first time partition as the first monitoring,
the second monitoring rule is a rule that limits a number of executions of the priority control and an execution time of the priority control in the second time partition, and
the monitoring process includes monitoring, as the second monitoring, the number of executions and the execution time of the priority control in the second time partition.

22. The control apparatus according to claim 12, wherein
the first monitoring rule is a rule that limits an execution time of the priority control in the first time partition,
processing circuitry monitors, as the first monitoring, the execution time of the priority control in the first time partition,
the second monitoring rule is a rule that limits a number of executions and an execution time of the priority control in the second time partition, and
processing circuitry monitors, as the second monitoring, the number of executions and the execution time of the priority control in the second time partition.

23. The control apparatus according to claim 12, wherein
the control interruption is an interruption that is out of management by an operating system, and
the interruption that is out of management is an interruption that can be accepted even while an interruption by the operating system is inhibited.

24. The control apparatus according to claim 13, wherein
the control interruption is an interruption that is out of management by an operating system, and
the interruption that is out of management is an interruption that can be accepted even while an interruption by the operating system is inhibited.

25. The control apparatus according to claim 22, wherein
the control interruption is an interruption that is out of management by an operating system, and
the interruption that is out of management is an interruption that can be accepted even while an interruption by the operating system is inhibited.

26. The control apparatus according to claim 12, wherein
the first monitoring rule is a rule that limits an execution time of the first time partition, the execution time being obtained by adding an execution time of the general control in the first time partition and an execution time of the priority control in the first time partition,
processing circuitry monitors the execution time of the first time partition as the first monitoring,
the second monitoring rule is a rule that limits a number of executions of the priority control and an execution time of the priority control in the second time partition, and
processing circuitry monitors, as the second monitoring, the number of executions and the execution time of the priority control in the second time partition.

27. The control apparatus according to claim 16, wherein
processing circuitry adds 1 to the number of executions of the priority control in the second time partition when the execution time of the first time partition has elapsed, in the first time partition.
